(19) United States
(12) Patent Application Publication
(10) Pub. No.: US 2025/0205912 A1
(43) Pub. Date: Jun. 26, 2025

(54) MULTI-BLADE KNIFE

(71) Applicant: Q.E.P. Co. Inc., Boca Raton, FL (US)

(72) Inventors: Bradley Scott MILLER, Boca Raton, FL (US); Joseph DEGUGLIMO, West Palm Beach, FL (US)

(73) Assignee: Q.E.P. Co. Inc., Boca Raton, FL (US)

(21) Appl. No.: 19/077,612

(22) Filed: Mar. 12, 2025

Related U.S. Application Data
(63) Continuation-in-part of application No. 18/942,918, filed on Nov. 11, 2024.
Application No. 18/942,918 is a continuation-in-part of application No. 18/533,738, filed on Dec. 8, 2023.

(51) Int. Cl. B26B 5/00; B26B 1/08; B26B 1/10

(52) U.S. Cl. CPC B26B 5/005; B26B 1/08; B26B 1/10; B26B 5/003

(57) ABSTRACT

A knife having a head, a body, and a first end at one end of the head, includes at least one blade positioning member having a first side and a second side; each side for retaining differently configured blades in the operative position or alternatively for positioning a blade at two operative positions. A holder for storing blades and/or blade positioning members.

### CROSS-REFERENCE TO RELATED APPLICATIONS

This application is a continuation-in-part of prior U.S. patent application Ser. No. 18/533,738, filed on Dec. 8, 2023, and U.S. patent application Ser. No. 18/942,918, filed on Nov. 11, 2024, the entireties of both of which are hereby incorporated by reference.

### FIELD

This application relates to a knife useful in the installation of different types of floors and/or floor coverings. In addition, this application relates to a knife providing storage for various items such as, without limitation, blades and/or cartridges or packages of replacement blades.

### BACKGROUND

The subject matter discussed in this background section should not be presumed to be prior art or analogous art merely as a result of its inclusion in this section. Similarly, a problem mentioned in this section or associated with the subject matter of this section should not be presumed to have been previously recognized in the prior arr. Rather, the subject matter in this section merely represents different approaches, which, in and of themselves, may also be inventions.

In a variety of professional crafts such as those relating to installation of flooring and floor covering, and in a variety of “do-it-yourself” or “DIY” activities, the need to have multiple knives for various uses is costly and unnecessarily consumes space in a “tool box.” For example, both a DIY and professional floor installer would need to have a knife for cutting carpet, a second knife for cutting vinyl tile/plank, a knife for cutting linoleum, and perhaps a conventional utility knife, all in addition to a knife that allows for adjustment of the length of the cutting blade extending outwardly from the knife itself.

Therefore, the need exists to provide a single knife that can effectively cut different types of floors or floor coverings thereby reducing the quantity of different knives to be purchased and stored until necessary, and that can provide cutting forces on different thickness of materials by extending the operative portion of the knife blade.

In addition, blades of the type described may become dull from extensive use and/or may snap or break and, therefore, it is beneficial to provide for storage of used blades and/or storage for replacement blades. The replacement blades may be individual blades or, alternatively, a quantity of blades typically sold in packages or cartridges, as well as storage for adapters of the type used so that different types of blades may be used.

Prior to the present invention, there was no solution to the above problems.

### SUMMARY

A knife that provides appropriate blades, and adjustable operable blade lengths/cutting-depths, and thus may be used on diverse types of floors or floor coverings, such as carpet, vinyl tile, etc.

The knife includes a head, a body, and a first end at one end of the head. At least one blade positioning member or insert may have opposed sides, with one side configured to engage and retain one type of blade and the second side configured to engage and retain a different type of blade. At least one blade positioning member or insert may have opposed sides, with one side configured to engage and retain one type of blade and the second side configured to engage and retain the same type of blade, with the two sides being configured to extend the blade to different cutting depths. At least one blade positioning member or insert may have opposed sides, with one side configured to engage and retain one type of blade and to extend the blade to different cutting depths.

Each blade positioning member or insert may be removable and reversible to accommodate the different configurations and/or positioning of blades.

The knife provides for storage of used blades and replacement blades. Replacement blades may be individually stored or stored in packages or cartridges. Blade positioning members or inserts may be stored in the knife.

### BRIEF DESCRIPTION OF THE FIGURES

In the following drawings, like reference numerals are used to refer to like elements. Although the following figures may depict certain embodiments or examples, the figures should not be interpreted in isolation but rather in the context of the specification and thus the invention is not to be considered as limited to the embodiments or examples depicted.

FIG. 1 is a side view of the front of a knife;

FIG. 2 is a side view of the rear of a knife;

FIG. 3 is a side view of the interior of the rear cover of the knife;

FIG. 4 is a side view of the interior of the front cover of the knife;

FIG. 5 is a front view of one embodiment of a blade positioning member or insert;

FIG. 6 is a rear view of one embodiment of a blade positioning member or insert;

FIG. 7 is a front view of one embodiment of a knife blade;

FIG. 8 is a front view of one embodiment of a knife blade extended to one position in a first embodiment of a blade positioning member or insert;

FIG. 9 is a front view of alone embodiment of a knife blade extended to a second position in a first embodiment of a blade positioning member or insert;

FIG. 10 is a partial view of one embodiment of a blade positioned in a first position in the head of the knife;

FIG. 11 is a partial view of one embodiment of a blade positioned in a second position in the head of a knife;

FIG. 12 is a front view of a second embodiment of a blade positioning member or insert;

FIG. 13 is a rear view of a second embodiment of a blade positioning member or insert;

FIG. 14 is a front view of a second embodiment of a knife blade;

FIG. 15 is a front view of a second embodiment of a knife blade extended to one position in a second embodiment of a blade positioning member or insert;

FIG. 16 is a front view of a second embodiment of a knife blade extended to a second position in a second embodiment of a blade positioning member or insert;

FIG. 17 is a front view of a third embodiment of a knife blade;

FIG. 18 is a front view of a third embodiment of a knife blade in an embodiment of a blade positioning member or insert;

FIG. 19 is a front view of a fourth embodiment of a knife blade;

FIG. 20 is front view of a fourth embodiment of a knife blade in an embodiment of a blade positioning member or insert;

FIG. 21 is a perspective view of a storage holder for blades and/or inserts;

FIG. 22 is an illustration of an embodiment of a blade on a storage holder;

FIG. 23 is an illustration of a package or cartridge which may contain blades or blade positioning members or inserts with the package or cartridge retained on a storage holder; and

FIG. 24 is a partial illustration of a storage holder in the rear cover of the knife.

### DETAILED DESCRIPTION

Although various embodiments or examples of the invention may have been motivated by various deficiencies with prior art knives which may be discussed or alluded to in one or more places in the specification, those embodiments or examples do not necessarily address any, much less all, of those deficiencies. In other words, different embodiments or examples of the invention may address deficiencies that may not be discussed in the specification. Some embodiments or examples may only partially address some deficiencies or just one deficiency in the prior art.

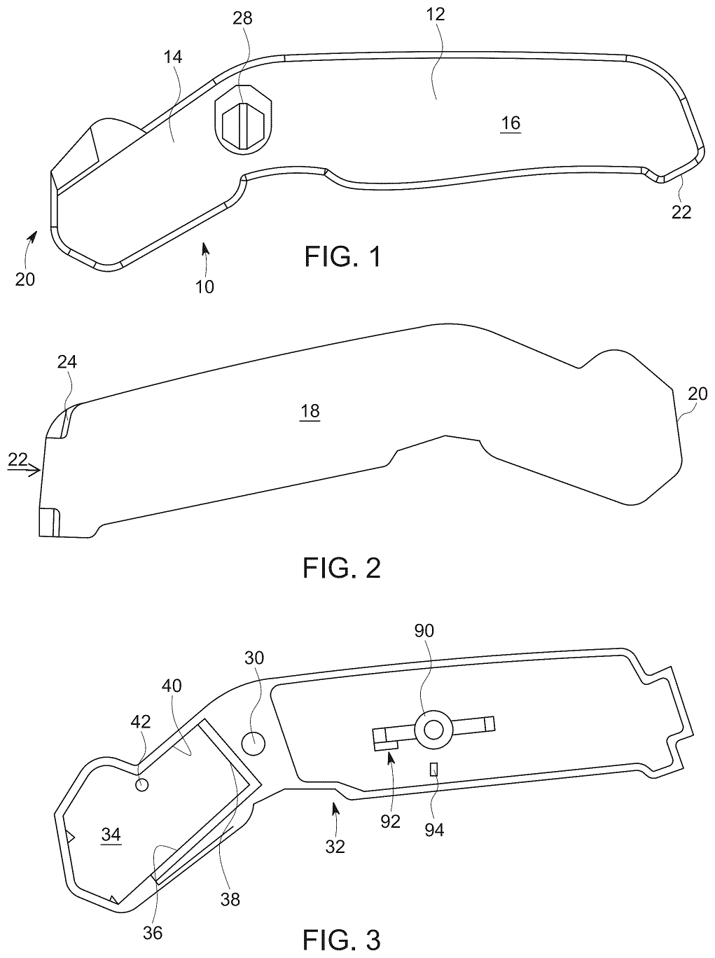

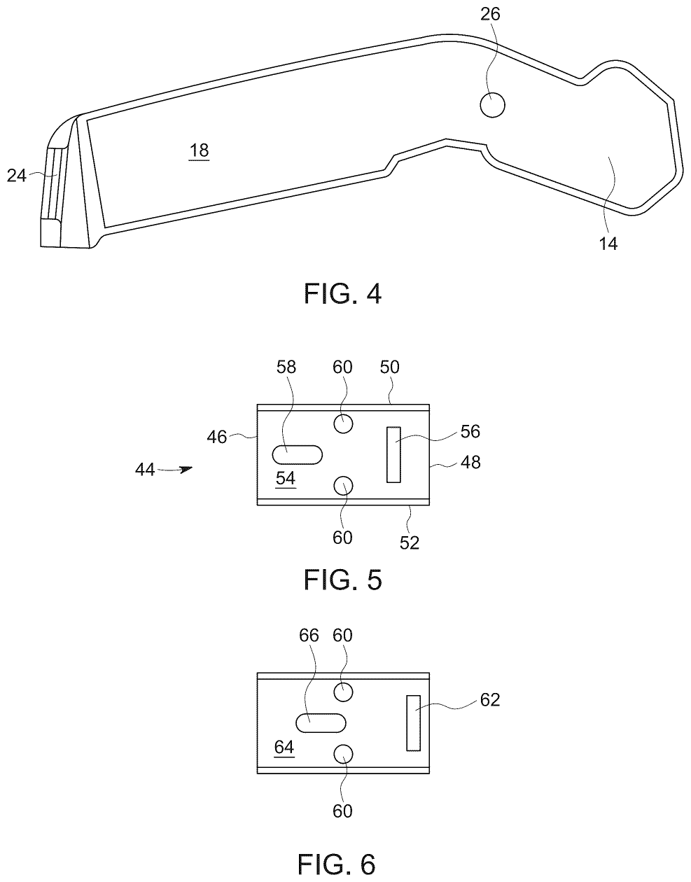

Referring to FIG. 1, a knife 10 is shown in the closed position. The knife includes a body 12 and a head 14. The knife 10 includes a front cover 16 (FIG. 1 and FIG. 4) and a rear cover 18 (FIG. 2 and FIG. 3) with the knife having a first end 20 and a second end 22. The interior of the knife is generally hollow to receive a blade and to provide for storage of blades, blade positioning members or inserts, and blade-containing cartridges as will be explained in greater detail. The knife is preferably formed of plastic as is conventional for various types of knives such as utility knives.

The front cover 16 and rear cover 18 are conveniently coupled together by a pivot 24 at the second end. A screw 26 extends through the front cover 16 and includes a gripping means 28 on the outside of the knife. A threaded recess 30 within the interior of the rear cover is positioned to receive and engage the screw 26 such that the front and rear covers may be secured together by the rotation of the screw.

The interior of the knife, and preferably the interior 32 of the head 14 of the rear cover, includes a generally rectangular recess 34. The recess extends inwardly such as from the first end 20 toward the second end 22 and is preferably bounded on three sides, preferably the bottom, the interior end, and the top, by three upwardly extending shoulders 36, 38 and 40 respectively. The shoulder 40 may be the interior top of the head of the knife. An optional magnet 42 may be preferably positioned in the recess such as adjacent the top shoulder 40.

Referring next to FIG. 5 and FIG. 6, a first side or front of one embodiment of a blade positioning member or insert 44 has a first end 46, a second end 48 with a length therebetween, a top 50 and a bottom 52 as illustrated in FIG. 5. The blade positioning member 44 is preferably made of metal or includes magnetizable material. In FIG. 6, a second side or rear of the insert 44 differs from the front or first side, as will now be explained.

The first side or front 54 of one embodiment of the insert or blade positioning member is illustrated in FIG. 5 and includes a generally upward projection 56 extending in a direction between the top and bottom of the insert, transverse to the insert length, and with the ends of the projections preferably spaced inwardly from the top and bottom of the insert. The insert includes an elongated projection 58 extending in a direction generally from one end to the other end of the insert in a direction toward the projection 56 along the length of the insert. The projection 58 is thus illustrated as parallel to the elongated direction of the insert, from one end to the other. Upper and lower circular recesses 60 are provided on the base of the insert to assist in engaging the magnet 42.

Referring next to FIG. 6, the second side 64 or rear of the first embodiment of the insert or blade positioning member 44 will now be described in greater detail. A generally upward projection 62 extends between the top and bottom of the insert with the ends of the projection preferably spaced inwardly from the top and bottom of the insert, for example transverse to the length of the insert. The insert includes an elongated projection 66 extending in a direction generally from one end of the insert toward the other end of the insert, in a direction toward the projection 62, for example parallel to the length of the first embodiment of the insert or blade positioning member 44. Again, upper and lower circular recesses 60 are provided on the base of the insert to assist in engaging magnet 42.

Comparing FIG. 5 and FIG. 6, the upward projection 62 on one side of the insert (FIG. 6) is closer to the nearest end of the insert when compared to the distance between the upward projection 56 on the other side of the insert and the nearest end (FIG. 5). Correspondingly, one end of the projection 66 on the second side 64 of the insert 44 (FIG. 6) is a greater distance from the nearest end 46 of the insert when compared to the distance between the end of the projection 58 on the first side 54 of the insert and the nearest end (FIG. 5).

Stated alternately, projection 56 is offset inwardly from the nearest end on the first side 54 of the insert (FIG. 5) a greater amount or greater distance than the offset of the projection 62 from the nearest end on the second side 64 of the insert (FIG. 6). Correspondingly, the projection 58 is offset inwardly from the nearest end on the first side of the insert 54 (FIG. 5) a lesser amount or lesser distance than the offset of the projection 66 from the nearest end on the second side 64 of the insert (FIG. 6).

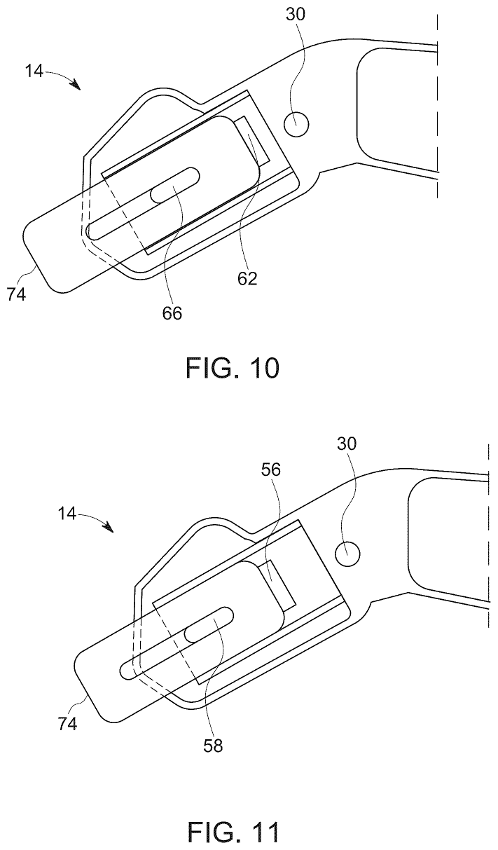

The first embodiment of the blade positioning member or insert 44 may thus have two positions in the recess in the head of the knife. One position would be for the projection 62 to be closer to the shoulder 38 in the recess 34, such as illustrated in FIG. 10. When a first embodiment of a blade is placed on the first embodiment of the insert, and the insert positioned in the head of the knife, as in FIG. 10, the end 74 of the blade 68 extends a first distance outwardly beyond the first end 20 of the knife head 14. In a second position, the projection 56 is closer to the shoulder 38 in the recess 34, as in FIG. 11. Again, when a first embodiment of the blade is positioned in a first embodiment of the insert, as in FIG. 11, the end 74 of the blade extends a second distance outwardly beyond the first end 20 of the knife head 14.

It should be appreciated that the difference between the first distance and the second distance that the blade extends beyond the first end of the knife or knife head depends on whether the blade is placed on the first side 54 or the second side 64 of the insert. The difference in the blade extension corresponds to the difference in distance between the projection 56 and the nearest end of the insert compared to the distance between the projection 62 and the nearest end of the insert.

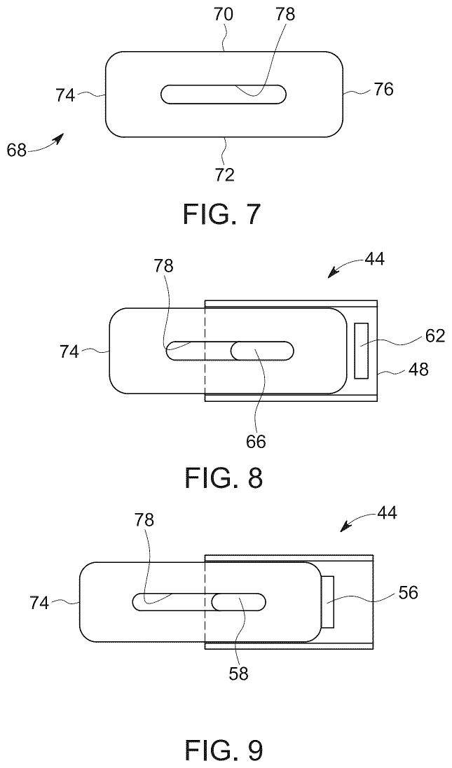

Referring next to FIG. 7, a first embodiment of a blade, such as a conventional carpet blade 68, is formed of metal and has upper and lower elongated cutting edges 70, 72. The blade is elongated between first and second blade ends 74, 76, and has an elongated opening, typically an elliptical opening 78 therethrough. The elongated opening may be centered relative to the cutting edges 70, 72, and relative to the ends 74,76 as is conventional. The length of the opening 78 is greater than the length of the projection 58, 66, on the front and back of the blade positioning member.

FIG. 8 illustrates a first embodiment of a blade 68 positioned on the first embodiment of the insert 44, with one end of the blade extending outwardly of the insert with the insert and blade oriented as in FIG. 6. The blade end 76 is adjacent to the upward projection 56, and the projection 58 of the insert extends through the opening 78 in the blade. The projection serves to limit or restrict blade movement relative to the front of the insert and thus, with the insert in the knife head, the projection extending through the opening, serves to limit or restrict inward movement of the blade 68 away from the knife end 20. The length of the opening 78 in the blade is greater than the length of the projection 66. In the illustration of FIG. 8, one end of the projection 66 engages one end of the opening 78 to limit or restrict outward movement of the blade. Thus, the combination of the projections and blade opening cooperate to limit or restrict both inward and outward blade movement.

Referring next to FIG. 9, the blade 68 is positioned on the first side 54 of the first embodiment of the insert 44, with the insert 44 oriented as in FIG. 5. The blade end 76 is adjacent the upward projection 56 and the projection 58 of the insert extends through the opening 78 in the blade. The projection 56 serves to limit or restrict lateral movement of the blade 68 relative to the knife end 20. The length of the opening 78 in the blade is greater than the length of the projection 66. Thus, with the insert in the knife head, the projection extending through the opening serves to limit or restrict inward movement of the blade 68 away from the knife end 20.

Referring next to FIG. 10, the first embodiment of the blade is positioned on the first side of the first embodiment of the insert or blade positioning member 44 as in FIG. 8, and the insert is positioned within the recess 34 of the knife head. A portion of the blade extends outwardly from the first end 20 of the knife such as for use in cutting carpet.

Referring next to FIG. 11, the first embodiment of the blade is positioned on the second side of the first embodiment of the insert or blade positioning member 44 as in FIG. 9, and the insert is positioned within the recess 34 of the knife head. A portion of the blade extends outwardly from the first end 20 of the knife such as for use in cutting carpet. The blade in FIG. 11 extends outwardly a greater distance from the first end 20 of the knife when compared to the blade in FIG. 10.

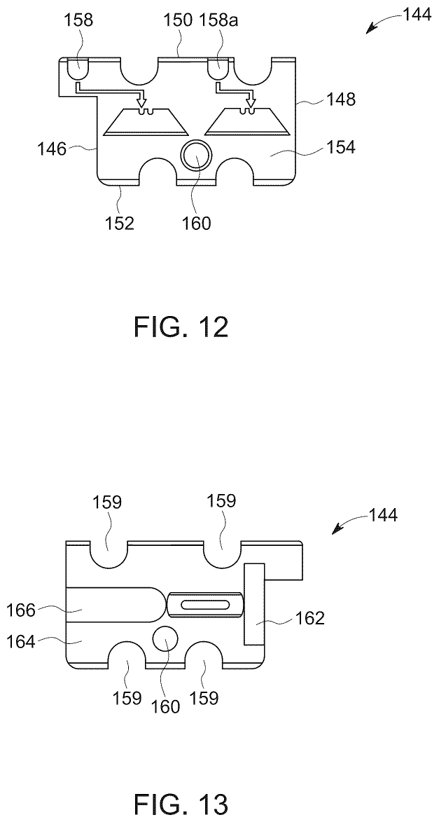

Referring next to FIG. 12 and FIG. 13, a first side or front 154 of a second embodiment of a blade positioning member or insert 144 has a first end 146, a second end 148 with a length therebetween, a top 150 and a bottom 152. The blade positioning member 144 is preferably made of metal or includes magnetizable material. In FIG. 13, a second side or rear 164 of the insert 144 is illustrated, which may optionally differ from the front or first side, as will be explained.

The first side or front 154 of this second embodiment of the insert or blade positioning member is illustrated in FIG. 12 and includes two laterally spaced-apart projections 158,158a, both extending downwardly from the top 150 in a direction toward the bottom 152 of the insert. The insert includes a series of laterally spaced apart recesses 1590 extending downwardly from the top 150 and a series of laterally spaced-apart recesses extending upwardly from the bottom 152. At least one circular recess 160 is provided on the base of the insert to assist in engaging the magnet 42.

Referring next to FIG. 13, the second side 164 or rear of the second embodiment of the insert or blade positioning member 144 will now be described in greater detail. A generally upward projection 162 extends between the top and bottom of the insert with the ends of the projection preferably spaced inwardly from the top and bottom of the insert, for example transverse to the length of the insert. The insert includes an elongated projection 166 extending in a direction generally from one end of the insert toward the other end of the insert, in a direction toward the projection 162, for example parallel to the length of the second embodiment of the insert or blade positioning member 144. Again, a circular recess 160 is provided on the insert to assist in engaging magnet 42.

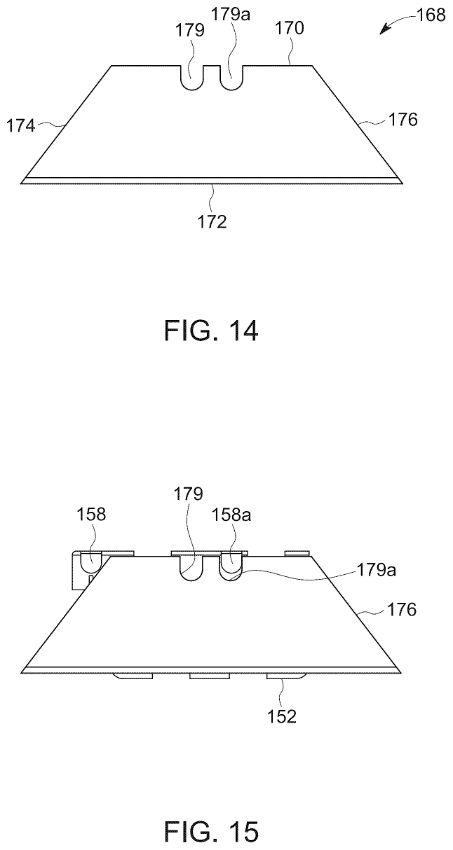

FIG. 14 illustrates a second embodiment of a blade, such as a conventional utility knife blade 168, is formed of metal and has upper and lower elongated edges 170, 172, with edge 172 being a cutting edge. The blade is elongated between first and second blade ends 174, 176, and has two spaced apart downwardly extending recesses 179, 179a, along the top edge.

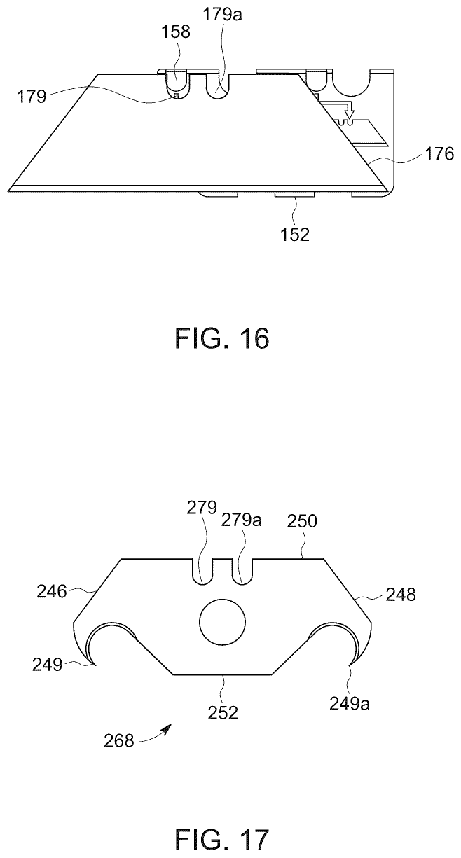

Referring next to FIG. 15, the second embodiment of the blade 168 is illustrated in a first position on the second embodiment of the insert 144 with an insert projection 158a in the recess 179a. This should be compared to FIG. 16 where the blade 168 is in a second position on the insert 144 with an insert projection 158 in the recess 179. The blade as mounted on the insert in FIG. 16 extends outwardly a greater distance than the blade as mounted on the insert in FIG. 15.

When the blade and insert combination of FIG. 15 is inserted in the recess in the head of the knife, the blade 168 will extend out a first distance beyond the end of the knife head. When the blade and insert combination of FIG. 16 is inserted in the recess in the head of the knife, the blade 168 will extend out a second distance beyond the end of the knife head. The difference between the first and second distances is related to the distances between projections 179, 179a, and the recesses 158, 158a, as well as which projection is engaged in a particular recess.

The back or second side 164 of the insert 144 may, for example, include a vertical projection 162 and a horizontal projection 166, such that a carpet knife blade 68 of the type illustrated in FIG. 7 may be positioned in the insert. The insert of FIG. 13 may be mounted on the insert in the same fashion that blade 68 of the first embodiment is mounted on the first embodiment of the insert 44 and thereafter mounted in the recess in the head of the knife as in FIG. 10.

Thus, the second embodiment of the insert may provide, on a first side, for two different blade mounting positions and thus two different blade extensions beyond the end of the knife with a first blade 168 and may provide, on the second side, for a different type of blade as compared to the type of blade on the first side of the insert.

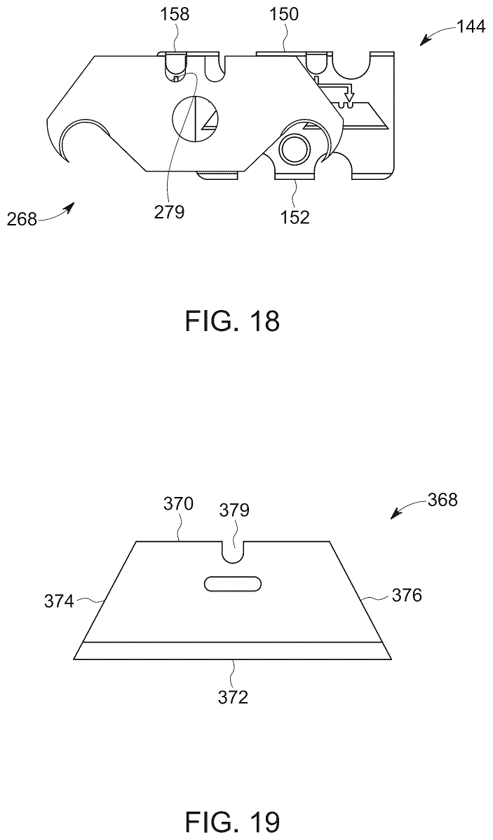

FIG. 17 illustrates a third embodiment of a blade of the type frequently referred to as a linoleum cutting blade or a hook blade 268. The blade of this third embodiment includes a top 250 and a bottom 252 and opposed ends 246, 248. The blade ends may each terminate in a hook-shaped cutting end 249, 249a. The top of the hook blade may include two laterally spaced-apart downwardly extending recesses 279, 279a. The projections 158 or 158a of the second embodiment of the insert (see FIG. 12) may selectively engage recesses 279 or 279a. When the blade of FIG. 17 is mounted in the insert of FIG. 12, as illustrated in FIG. 18, and the combination is inserted in the recess in the head of the knife, the blade 268 will extend out either a first distance beyond the end of the knife head or a second distance beyond the end of the knife head. The difference between the first and second distances is related to the distances between projections 179, 179a, and the recesses 279, 279a, as well as which projection is engaged in a particular recess.

FIG. 19 illustrates yet another embodiment of a blade 368 such as a different form of a conventional utility knife blade which is formed of metal and has upper and lower elongated edges 370, 372, with edge 372 being a cutting edge. The blade is elongated between first and second blade ends 374, 376. The blade has a single downwardly extending recesses 379 along the top edge.

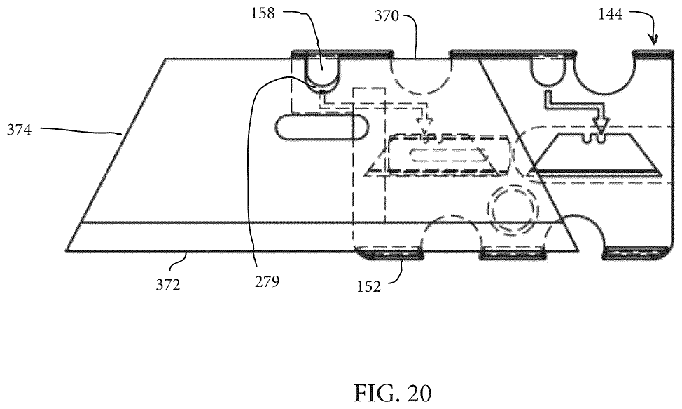

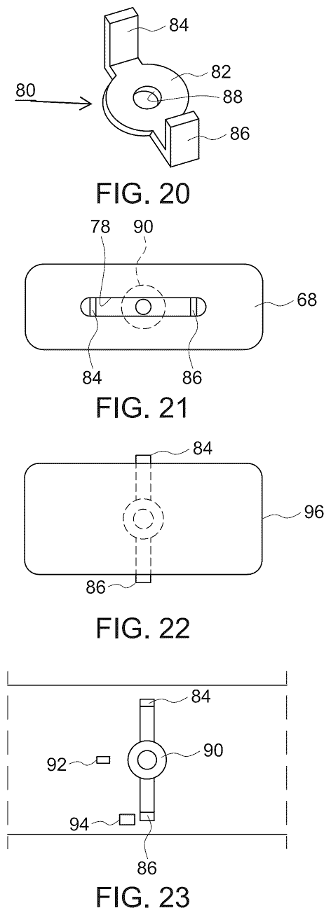

FIG. 20 illustrates another embodiment with the blade 368 of FIG. 19 mounted in the insert or blade positioning member 144 of FIG. 12 with the projection 158 mounted in the recess 379. If desired, the blade of FIG. 19 may be mounted in the insert with the projection 158a mounted in the recess 379 with the result that the blade end 374 will extend outwardly a lesser distance from the insert, and thus from the knife end, when compared to the blade mounted with the projection 158 in the recess 379.

Thus the various combinations of the various embodiments of blades and inserts provides for different types of blades to be mounted on opposite sides of an insert and/or for the blades, when mounted in the insert and inserted in the recess in the head of the knife, to extend outwardly different distances, and in the latter case, the different distances may be achieved by the blades being engaged in different positions on the same side of the insert or by the blades being engaged on different sides of the insert.

Referring next to FIG. 22 through FIG. 24, the feature of storage of used and/or replacement blades and/or blade cartridges and/or inserts will now be explained. For safety, it is preferred that the knife blade is removed when the knife is being stored. The present knife includes means for storing one or more blades and/or for storage of a conventional package or cartridge containing multiple blades, or for storage of inserts. The knife includes a U-shaped holder 80 having a base 82 and opposed legs 84, 86. The holder base includes an aperture 88 so that the holder may be movably attached, preferably for rotational movement, to the interior of the rear cover 18 of the knife body 12. The spacing between the opposed legs 84, 86, is less than the length of the opening in a carpet knife blade.

The interior of the rear cover includes a projection 90 extending upwardly from the wall of the handle, to engage the aperture 88 in the holder 80 such that the holder may rotate relative to the knife handle. The wall further includes upward projection 92, positioned slightly below the middle of the knife body. The projection 92 limits counterclockwise rotation of the holder 80. Positioning the projection slightly below the middle of the knife body allows the holder to rotate to a horizontal position as illustrated in FIG. 22.

The interior of the rear cover includes a projection 94, positioned slightly to the side relative to a vertical position of the holder, to limit clockwise rotation of the holder. Positioning the projection slightly to the side as illustrated in FIG. 24 allows the holder to rotate to a vertical position.

The holder 80 in the horizontal position as in FIG. 22 permits storage of one or more blades 68 thereon as the spacing between the holder legs 84, 86 is slightly less than the length of the opening 78 in carpet blade.

It is conventional for multiple blades to be sold in generally rectangular cartridges 96. This is true not only for carpet blades, but also for the blades of each of the embodiments described above. The cartridge may be stored within the knife handle by first rotating the holder to the vertical position as illustrated in FIG. 23 and FIG. 24, with the cartridge positioned between the legs 84, 86 of holder 80 as illustrated in FIG. 23.

Additionally, the inserts of the various embodiments may be secured within the holder 80, such as by a frictional fit between the legs 84, 86. The inserts may be within packages or cartridges or secured in the holder without the use of cartridges or packages.

The knife is opened by unscrewing the front cover from the rear cover to conveniently pivot the front cover away from the rear cover. With the covers thus separated, inserts and blades may be positioned, removed, stored, etc. The front and rear covers are then closed and secured together.

Each embodiment or variation disclosed herein may be used or otherwise combined with any other embodiment or variation.

Although the invention has been described with reference to specific embodiments, examples and variations, it will be understood by those skilled in the art that various changes may be made and/or equivalents may be submitted without departing from the spirit and scope of the invention and/or without departing from the essential teachings of the invention. The invention, therefore, should be limited only by the scope of the claims and equivalents thereof.

1. A knife having a head, a body, and a first end at one end of the head, the improvement comprising at least one of (a), (b), (c), (d) wherein:
(a) a blade positioning member adapted to be inserted in the head of the knife, the blade positioning member having a first side and a second side, each side for retaining a blade with the blade extending outwardly from the head of the knife, each side for retaining a blade outwardly a different distance from the head of the knife;
(b) a blade positioning member adapted to be inserted in the head of the knife, the blade positioning member having a first side and a second side, each side for retaining a blade with the blade extending outwardly from the head of the knife, each side for retaining a different configuration of a blade with the blade extending outwardly from the head of the knife;
(c) a blade positioning member adapted to be inserted in the head of the knife, the blade positioning member having a first side and a second side, the first side for retaining a blade with the blade extending outwardly from the head of the knife, the first side for further retaining a blade with the blade extending outwardly from the head of the knife at more than one distance;
(d) a holder in the body of the knife, the holder for retaining at least one of (1) or (2) wherein:
(1) at least one blade;
(2) at least one blade positioning member.

2. The knife according to claim 1, including at least two of (a), (b), (c), (d).

3. The knife according to claim 1, including at least three of (a), (b), (c), (d).

4. The knife according to claim 1, including all of (a), (b), (c), (d).

5. The knife according to claim 1, including both (d) 1 and (d) 2.

6. The knife according to claim 1, including a blade positioning member, wherein the blade positioning member has a first side and a second side;
the first side of the blade positioning member for retaining a first blade in an operative position in the knife head;
the second side of the blade positioning member for retaining a second blade in an operative position in the knife head;
each of said first blade and second blade having respective first and second blade configurations, respectively; and
said first and second blade configurations differing from each other.

7. A knife according to claim 1, including a blade positioning member, wherein: the blade positioning member has a first side and a second side;
the first side of said blade positioning member is for retaining a first blade in a first position with a first blade end at a first distance from said first end of said head; and
for alternatively retaining said first blade in a second position with said first blade end at a second distance from said first end of said head;
said first and second positions being offset relative to each other in a direction outwardly from said head.

8. A knife according to claim 7, wherein said first side of said blade positioning member includes a first means for engaging said first blade in said first position and second means for engaging said first blade in said second position.

9. A knife according to claim 1, and including a blade positioning member, wherein said blade positioning member is reversable.

10. A knife according to claim 1, wherein said knife includes a holder for storage of blades, said holder being positioned in said body.

11. A knife according to claim 10, wherein said knife includes a holder for storage of blades, said holder being positioned in said body, said holder having two discrete positions, each position for storage of blades.

12. A knife according to claim 1, including at least two blade positioning members, wherein:
a first blade is positionable in at least two positions on a first side of a first blade positioning member;
a second blade is positionable in at least one position on a second side of said first blade positioning member;
a third blade is positionable in at least one position on a second side of a second blade positioning member; and
each blade is configured differently when compared to the other two blades.
